(19) United States
(12) Patent Application Publication
(10) Pub. No.: US 2003/0163248 A1
(43) Pub. Date: Aug. 28, 2003

(54) Information management system

(75) Inventor: Kenichi Mizuishi, Hachiohji (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 10/352,150

(22) Filed: Jan. 28, 2003

(30) Foreign Application Priority Data
Feb. 22, 2002 (JP) 2002-046004

(51) Int. Cl. G08G 1/00

(52) U.S. Cl. 701/117; 340/995.13

(57) ABSTRACT

An information management center 20 transmits second probe information managed by the information management center 20 to an on-vehicle system 10 on the condition that the information management center 20 is provided with first probe information collected by the on-vehicle system 10. The on-vehicle system 10 transmits user ID information to the information management center 20 together with the first probe information only when it is judged that a user has an intention of transmitting the user ID information. The information management center 10 gives a discount point for a use fee of the second probe information only when the information management center 10 receives the user ID information together with the first probe information. Thus, information can be collected from a greater number of mobile terminals.

### BACKGROUND OF THE INVENTION

The present invention relates to an information management system that collects a moving speed and a moving direction from mobile terminals on an area basis to manage a state of each area, and more particularly to a technology that is suitable for a traffic information management system which uses a probe car.

A traffic information management system which manages traffic information by collecting running information from a running vehicle is proposed as an information management system that collects a moving speed and a moving direction from mobile terminals on an area basis to manage a state of each area. The traffic information management system comprises a traffic information management device, and an on-vehicle device that is mounted on a vehicle so as to communicate with this traffic information management device. The vehicle equipped with this on-vehicle device is called a probe car.

The on-vehicle device collects running information of the probe car equipped with the on-vehicle device. The running information includes the following: a running speed; a direction in which the probe car is running; and a following distance between the probe car and a vehicle ahead. Then, the collected running information is transmitted to the traffic information management device together with position information of the vehicle.

According to the position information which has been received together with the running information, the traffic information management device classifies the running information collected from the probe car on a road section basis, for example. Using the running information classified on a road section basis, a state of traffic jam in each section is estimated. The result of the estimation is managed as traffic information.

According to this traffic information management system, it is possible to provide a user of the system with traffic information that always requires real-time update.

In order to manage traffic information, which always requires real-time update, over a wide area in such a traffic information management system, a mechanism for urging many owners of a general-purpose vehicle to participate in the traffic information management system as a probe car is required.

On this point, there is the technology described in Japanese Patent Laid-Open No. 2000-172977 in which a use fee of traffic information is determined by balancing the supplied amount of running information against the received amount of traffic information. However, even this technology is not sufficient for a mechanism for urging many owners of a general-purpose vehicle to participate in the system as a probe car. In order to urge many owners of a general-purpose vehicle to participate in the system as a probe car, it is also necessary to consider the protection of privacy and the like.

### SUMMARY OF THE INVENTION

The present invention has been made in view of the foregoing. Therefore, an object of the present invention is to provide a mechanism for collecting information from the greater number of mobile terminals in an information management system such as a traffic information management system.

For the purpose of solving the above-mentioned problems, an information management system according to the present invention is so devised that a mobile terminal can enjoy information (referred to as second probe information) managed by an information management device on the condition that the mobile terminal provides information (referred to as first probe information) collected by the mobile terminal. To be more specific, in such an information management system, since all users of the system become providers of the first probe information, as the number of system users increases, the number of providers of the first probe information also increases without fail.

In addition, the user of the mobile terminal is inquired whether or not the user will transmit user ID information. Only when it is judged that the user has an intention of transmitting the user ID information, the user ID information is transmitted from the mobile terminal to the information management device together with the first probe information. Then, only when the information management device receives the user ID information together with the first probe information, the information management device associates management information, which includes receiving date and time of the first probe information, and position information transmitted together with the first probe information, with the user ID information before registering the management information as discount information of a second probe information use fee. In other words, if the user gives up the discount of the second probe information use fee, the user is not required to transmit the user ID information to the information management device. The protection of privacy of the mobile terminal user was taken into consideration in this manner.

According to one aspect of the present invention, there is provided an information management system, the information management system comprising at least one mobile terminal, and an information management device that is connected to the mobile terminal via a network.

The information management device comprising: first probe information receiving means for receiving first probe information from the mobile terminal together with position information; second probe information registering means for classifying the first probe information received by the first probe information receiving means on an area basis, the area being determined by the position information received together with the first probe information, and processing the first probe information into second probe information before registering the second probe information; history registering means by which if the first probe information received by the first probe information receiving means has user ID information as well as the position information, management information including the position information and its received date and time is associated with the user ID information, and is registered as discount information of a second probe information use fee; and second probe information transmitting means for transmitting second probe information about an area requested by the sender to a sender of the first probe information received by the first probe information receiving means.

In addition, the mobile terminal comprising: position information obtaining means for obtaining position information of the mobile terminal; first probe information obtaining means for obtaining the first probe information; storing means for storing the user ID information; user ID transmission acknowledging means for accepting acknowledgment of transmission of the user ID information from a user; and second probe information obtaining means by which if the user ID transmission acknowledging means judges that the user ID information is not transmitted, the position information obtained by the position information obtaining means, the first probe information obtained by the first probe information obtaining means, and a request area, the second probe information of which is requested, are transmitted to the information management device, whereas if the user ID transmission acknowledging means judges that the user ID information is transmitted, the user ID information stored in the storing means is transmitted to the information management device together with the position information, the first probe information, and the request area so as to receive the second probe information of the request area from the information management device.

In the information management system having the above-mentioned configuration, the information providing device may also be provided with an advertisement information database in which advertisement information of a facility located in each area is registered. Further, the second probe information transmitting means may also be configured to transmit the second probe information, which is classified and registered corresponding to a request area of the second probe information, the request area having been received together with the first probe information, to a sender of the first probe information received by the first probe information receiving means, together with advertisement information which is associated with the request area and is registered in the advertisement information database.

With this configuration, since income from advertisement rates can be expected, a use fee of the second probe information can be reduced. As a result, it is expected that the number of system users will increase, and that the number of providers of the first probe information will also increase.

In this case, the following method may also be used: judging whether or not a system user views and/or uses advertisement information; and reflecting the result of the judgment in discount information of a second probe information use fee of the system user.

To be more specific, the second probe information obtaining means is configured to notify a user of advertisement information if the second probe information obtaining means receives the advertisement information from the information management device together with the second probe information. In addition, the mobile terminal is further provided with a viewing acknowledgment transmitting means that accepts, from a user, viewing acknowledgment of the advertisement-information notified by the second probe information obtaining means, and that transmits the viewing acknowledgment to the information management device together with the user ID information stored in the storing means. On the other hand, the information management device is further provided with a viewing acknowledgment receiving means that receives viewing acknowledgment from the mobile terminal. Moreover, the history registering means is configured to associate management information, which includes the viewing acknowledgment received by the viewing acknowledgment receiving means and its received date and time, with the user ID information given to the viewing acknowledgment before registering the management information as discount information of a second probe information use fee.

Otherwise, the second probe information obtaining means is configured to notify a user of advertisement information if the second probe information obtaining means receives the advertisement information from the information management device together with the second probe information. In addition, the mobile terminal is further provided with a use acknowledgment transmitting means that transmits use acknowledgment of the advertisement information notified by the second probe information obtaining means to the information management device together with ID information stored in the storing means. On the other hand, the information management device is further provided with a use acknowledgment receiving means that receives use acknowledgment from the mobile terminal. Moreover, the history registering means is configured to associate management information, which includes the use acknowledgment received by the use acknowledgment receiving means and its received date and time, with the user ID information given to the use acknowledgment before registering the management information as discount information of a second probe information use fee.

### BRIEF DESCRIPTION OF THE DRAWINGS

Other objects and advantages of the invention will become apparent from the following description of embodiments with reference to the accompanying drawings in which:

FIG. 1 is a schematic diagram illustrating an information management system to which one embodiment according to the present invention is applied;

FIG. 2 is a diagram schematically illustrating a configuration of an on-vehicle system 10 shown in FIG. 1;

FIG. 3 is a diagram schematically illustrating a configuration of an information management center 20 shown in FIG. 1;

FIG. 4 is a diagram illustrating an example of how a history-information management DB 205 shown in FIG. 2 stores registered information;

FIG. 5 is a diagram illustrating an example of how an advertisement-information management DB 206 shown in FIG. 2 stores registered information;

FIG. 6 is a diagram illustrating an example of how a second probe-information management DB 207 shown in FIG. 2 stores registered information;

FIG. 7 is a diagram schematically illustrating a configuration of an advertiser terminal 30 shown in FIG. 2; and

FIG. 8 is a diagram illustrating a process flow of an information management system to which one embodiment according to the present invention is applied.

### DETAILED DESCRIPTION OF THE PREFERRED EMBODIMENTS

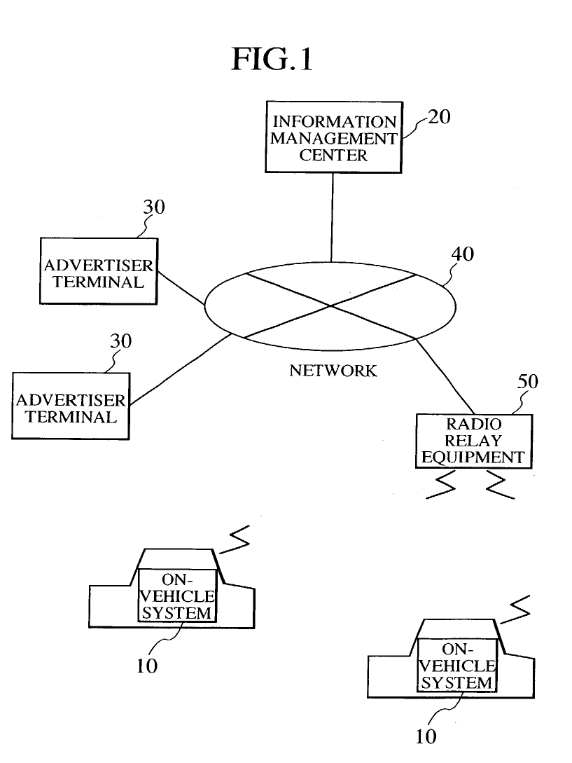

An embodiment of the present invention will be described below. Here, a case where an information management system according to the present invention is applied to a traffic information management system will be exemplified. FIG. 1 is a schematic diagram illustrating a traffic information management system to which one embodiment according to the present invention is applied.

As illustrated in the figure, the traffic information management system according to this embodiment comprises the following: an on-vehicle system 10 mounted on a vehicle, which is used in the vehicle; an information management center 20 that manages traffic information, advertisement information and the like, which are given to the on-vehicle system 10 as second probe information; and an advertiser terminal 30 that is installed and used in, for example, a facility operated by an advertiser of the advertisement information. They are connected to one anther via a network 40 to constitute the traffic information management system. The on-vehicle system 10 is connected to the network 40 through radio relay equipment 50.

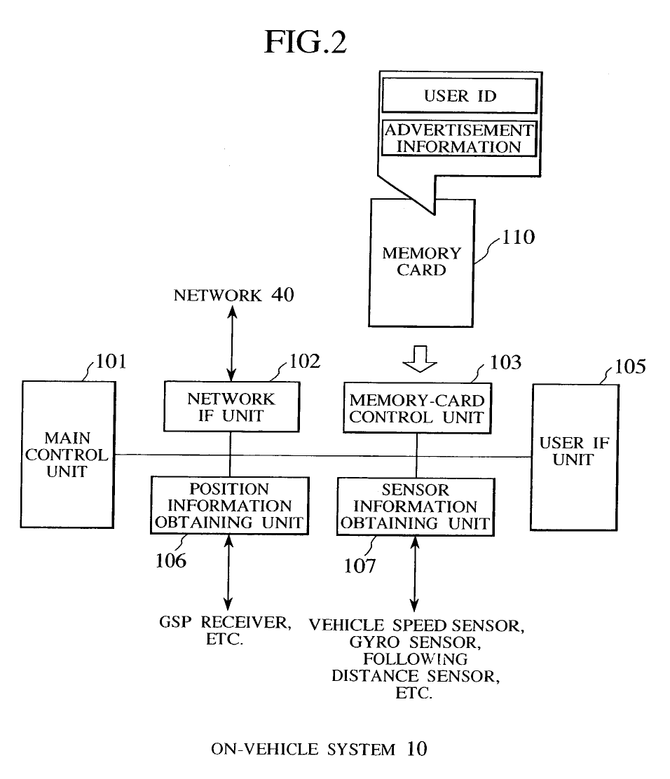

FIG. 2 is a diagram schematically illustrating a configuration of the on-vehicle system 10.

As illustrated in the figure, the on-vehicle system 10 comprises a network IF (interface) unit 102, a memory-card control unit 103, a position information obtaining unit 106, a sensor information obtaining unit 107, a user IF unit 105, and a main control unit 102. The network IF (interface) unit 102 is used for the connection to the network 40 through the radio relay equipment 50 by means of radio communication. The memory-card control unit 103 controls reading from and writing to a memory card 110 in which user ID information, advertisement information and the like are registered. The position information obtaining unit 106 obtains vehicle position information using a GPS receiver, for example. The sensor information obtaining unit 107 obtains sensor information from various kinds of sensors such as a vehicle speed sensor, a gyro sensor, and a following distance sensor (including an on-vehicle radar, an on-vehicle camera, and an on-vehicle microphone), which are mounted on a vehicle. The user IF unit 105 is used for exchanging information with a user, and comprises a display panel and an operation panel. The main control unit 101 performs centralized control of these units.

Using a portable computer system comprising, for example, a CPU, a RAM, a ROM, a radio communication device (or an interface with the radio communication device), interfaces with various kinds of sensors, and user interfaces such as a display and operation buttons, the on-vehicle system 10 having the configuration described above can be realized by executing a given program, which is stored in the ROM, by the CPU.

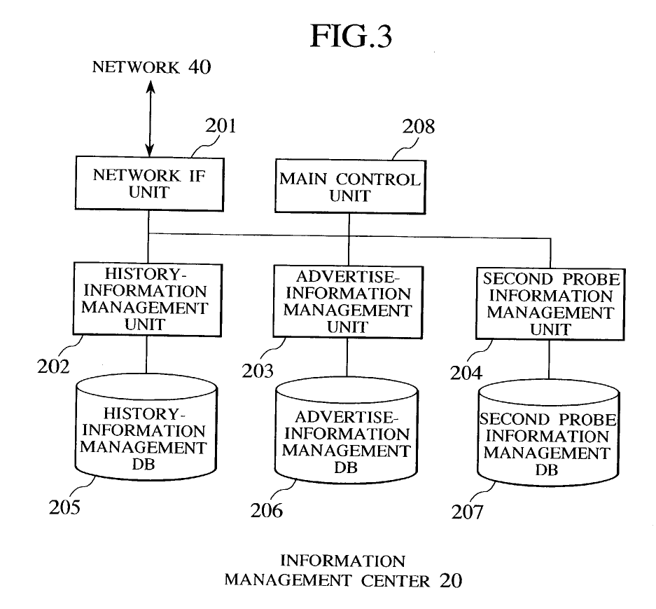

FIG. 3 is a diagram schematically illustrating a configuration of the information management center 20.

As illustrated in the figure, the information management center 20 comprises a network IF unit 201, a history-information management unit 202, an advertisement unit 203, and a second probe-information management unit 204, and a control unit 205. The network IF unit 201 is used for the connection to the network 40. The history-information management unit 202 registers a point, which is used for a discount on a use fee of the second probe information, in a history-information management DB 205 together with a cause of the occurrence of the point. The advertisement-information management unit 203 manages an advertisement-information management DB 206 in which the advertisement information is registered together with information about the advertiser. The second probe-information management unit 204 classifies the first probe information collected from the on-vehicle system 10 before processing the classified information into the second probe information, and registers the second probe information in a second probe-information management DB 207. The control unit 208 performs centralized control of these units.

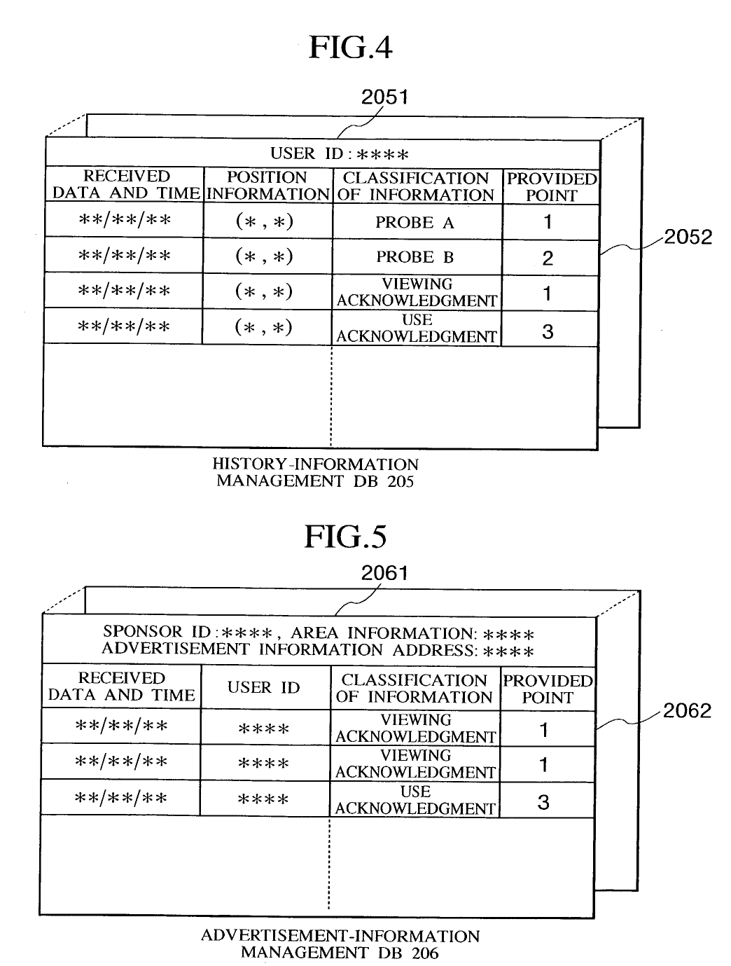

FIG. 4 is a diagram illustrating an example of how the history-information management DB 205 stores registered information.

As illustrated in the figure, in the history-information management DB 205, a table 2051 used for managing a history of the occurrence of use-fee discount points for the second probe information is registered for each user ID of a user of this information management system. Actions that are treated as causes of the occurrence of a use-fee discount point include transmission of the first probe information, transmission of viewing acknowledgment of advertisement information, and transmission of use acknowledgment of advertisement information. When one of the actions is performed, the history-information management unit 202 registers a record 2052 in the table 2051 only when user ID information is transmitted from the on-vehicle system 10.

The record 2052 has the following fields: a field for storing the received date and time of user ID information; a field for storing position information which is transmitted together with the user ID information; a field for storing the classification of information about a cause of the occurrence of a point, which is transmitted together with the user ID information; and a field for storing a point occurred. The number of points occurred is predetermined according to the classification of information about a cause of the occurrence of a point. Here, the first probe information is divided into two kinds, a probe A and a probe B, according to the value of the information. It is so devised that the probe B having the higher value of information generates the higher number of points. In this case, information which needs urgent attention such as the occurrence of an accident is classified as the probe B having the high value of information; and running information and the like, are classified as the probe A. In addition, it is so devised that the use acknowledgment of advertisement information (acknowledgment of action such as purchasing, which has been performed according to advertisement information) generates the number of points higher than that generated by the viewing acknowledgment of advertisement information.

FIG. 5 is a diagram illustrating an example of how the advertisement-information management DB 206 stores registered information.

As illustrated in the figure, for each sponsor who provides advertisement information, a table 2061 is registered in the advertisement-information management DB 206. The table 2061 is used to manage the following information: sponsor ID information; a stored location of the advertisement information; an area where the advertisement information is provided: and a history of the occurrence of a point relating to an advertisement rate. Actions that are treated as a cause of the occurrence of an advertisement-rate related point include transmission of advertisement-information viewing acknowledgment, and transmission of advertisement-information using acknowledgment, from the on-vehicle system 10. When one of the actions is performed, the history-information management unit 202 registers a record 2062 in the table 2061 only when user ID information is transmitted from the on-vehicle system 10.

The record 2062 has the following fields: a field for storing received date and time of user ID information; a field for storing the user ID information; a field for storing classification of acknowledge information as a cause of the occurrence of a point, which is transmitted together with the user ID information; and a field for storing a point occurred. The number of points occurred is predetermined according to the classification of acknowledge information as a cause of the occurrence of a point. Here, the advertisement-information using acknowledgment generates the number of points higher than that generated by the advertisement-information viewing acknowledgment.

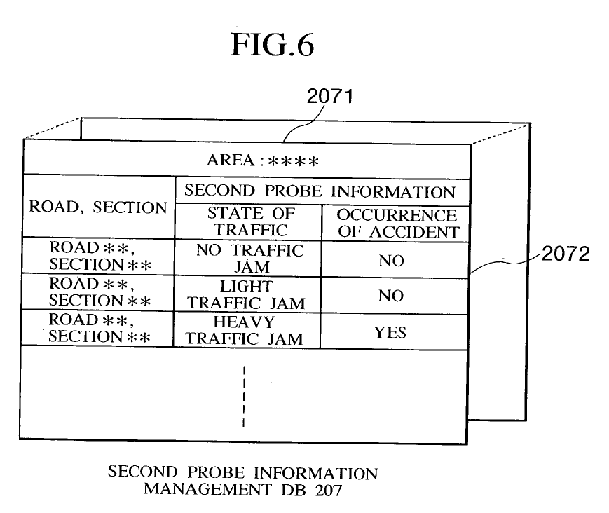

FIG. 6 is a diagram illustrating an example of how the second probe-information management DB 207 stores registered information.

As illustrated in the figure, a table 2071 which is used to manage the second probe information in each road section (a state of traffic, and whether or not an accident has occurred) is registered in the second probe-information management DB 207 on an area basis. In each of the tables 2071, a record 2072, which is provided on a road section basis, has the following fields: a field in which position information of a road section is registered; a field in which a state of traffic (state of traffic jam) in the road section is registered; and a field in which whether or not an accident has occurred in the road section is registered. In this case, even if it is the same road section, up and down of the same section are treated differently.

Using a computer system comprising, for example, a CPU, a RAM, a HDD, a network interface, and a user interface such as a display and operation buttons, the information management center 10 having the configuration described above can be realized by executing a given program, which is stored in the HDD or the like, by the CPU.

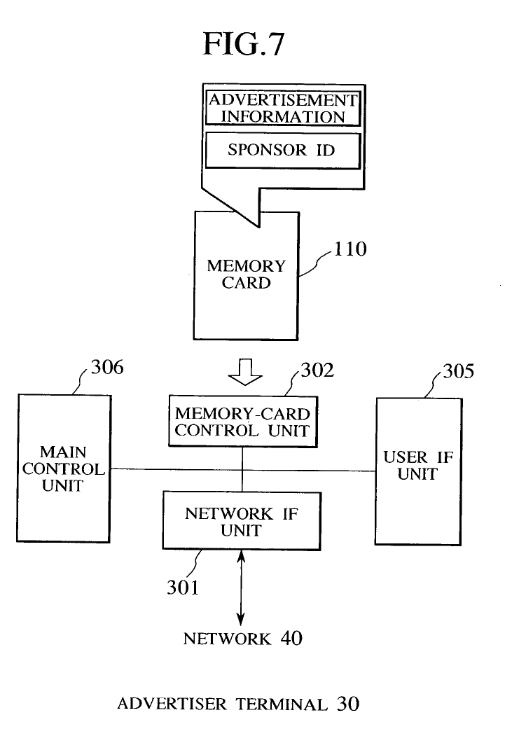

FIG. 7 is a diagram schematically illustrating a configuration of the advertiser terminal 30.

As illustrated in the figure, the advertiser terminal 30 comprises a network IF unit 301, a memory-card control unit 302, a user IF unit 305, and a main control unit 306. The network IF unit 301 is used for the connection to the network 50. The memory-card control unit 302 controls reading from and writing to a memory card 110 presented by a user of this information management system. The user IF unit 305 comprising a display and a keyboard exchanges information with a user. The main control unit 306 performs centralized control of these units.

Using a computer system having the same configuration as that of the information management center 10, the advertiser terminal 30 having the configuration described above can also be realized by executing a given program, which is stored in the HDD or the like, by the CPU.

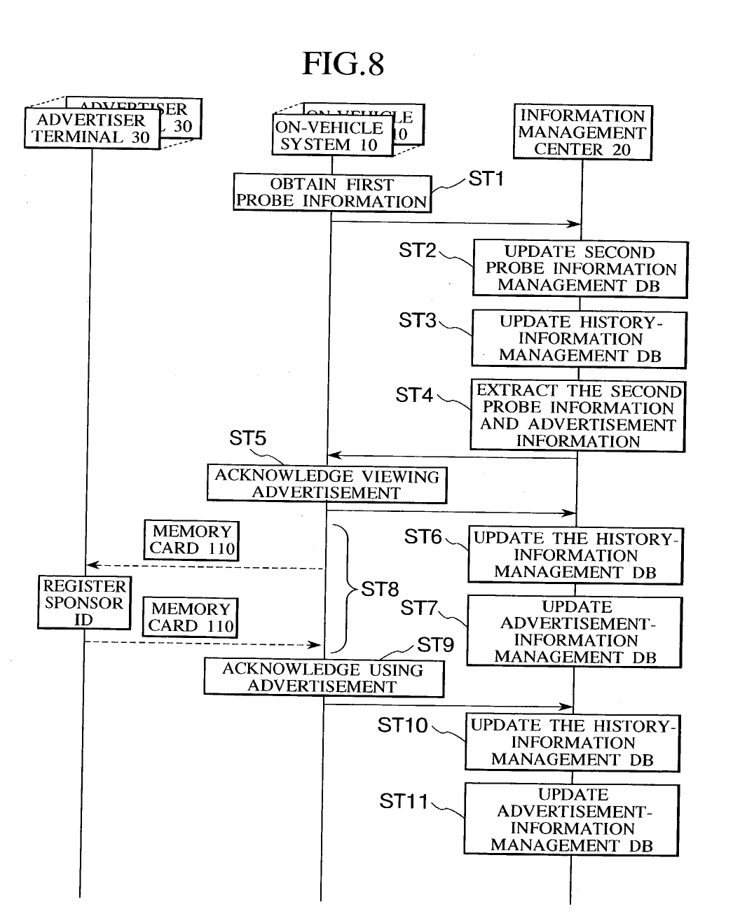

Next, operation of the traffic information management system to which this embodiment is applied will be described. FIG. 8 is a diagram illustrating how the traffic information management system to which this embodiment is applied operates.

(1) ST1: Transmission Processing of the First Probe Information

The on-vehicle system 10 transmits a first probe information to the information management center 20 periodically or according to an instruction by a user.

More specifically, the main control unit 101 periodically calculates vehicle speed information, driving direction information, and following distance information on the basis of sensor information obtained from various kinds of on-vehicle sensors through the sensor information obtaining unit 107. Then, the vehicle speed information and the following distance information which are used as the first probe information are transmitted from the network IF unit 102 to the information management center 20 together with the driving direction information, and vehicle position information which is calculated on the basis of information obtained from a GPS receiver or the like through the position information obtaining unit 106. In addition, as soon as the user notifies through the user IF unit 105 that an accident has occurred, the main control unit 101 transmits information indicating the occurrence of the accident, which is used as the first probe information, from the network IF unit 102 to the information management center 20 together with the driving direction information and the vehicle position information.

Here, if user settings accepted through the user IF unit 105 causes a flag, which indicates whether or not user ID information registered in a memory or the like is transmitted, to be set at “transmit”, the main control unit 101 controls, for example, the memory-card control unit 103 to read user ID information from the memory card 110 inserted in the on-vehicle system 10. After that, this user ID information is transmitted to the information management center 20 together with the first probe information, the vehicle position information, and the driving direction information.

Further, if user settings accepted through the user IF unit 105 causes a flag, which indicates whether or not the second probe information registered in the memory or the like is received, to be set at “receive”, the main control unit 101 transmits a request area of second probe information (for example, the vicinities of a current location (location of vehicle)), which is specified by the user settings, to the information management center 20 together with the first probe information, the vehicle position information, and the driving direction information.

(2) ST2: Update Processing of the Second Probe-Information Management DB

The information management center 20 classifies the pieces of the first probe information received from the plurality of on-vehicle systems 10 on a road section basis. Then, on a road section basis, according to the tendency indicated by each of the first probe information which has been received within a given period of time, the information management center 20 judges a state of traffic in this road section, and also judges whether or not an accident has occurred in this road section. According to the result of the judgment, the information management center 20 updates the second probe-information management DB 207.

To be more specific, according to the vehicle position information received together with the first probe information, the second probe-information management unit 204 classifies, on an area basis, the first probe information collected from each of the plurality of on-vehicle systems 10. Moreover, the second probe-information management unit 204 classifies the pieces of the first probe information on a road section basis according to the vehicle position information, the driving direction information received together with the first probe information, and road data which is not illustrate.

Next, the second probe-information management unit 204 periodically determines a mean value of vehicle speed information, and a mean value of following distance information, on a road section basis. The vehicle speed information and the following distance information are included in each of the pieces of the first probe information collected for the given period of time up to the current time. After that, according to the mean values of the above-mentioned information, the second probe-information management unit 204 judges a degree of traffic jam in the target road section. Then, using the result of the judgment, the second probe-information management unit 204 updates a field for storing a state of traffic, which is in the record 2072 of the target road section.

Further, the second probe-information management unit 204 periodically determines, on a road section basis, a ratio between the total number of first probe information collected for the given period of time up to the current time and the total number of accident information included in the first probe information. Then, according to this ratio, the second probe-information management unit 204 judges whether or not an accident of which a user should be notified has occurred in the target road section. After that, using the result of the judgment, the second probe-information management unit 204 updates a field for storing the occurrence of an accident, which is in the record 2072 of the target road section.

In this case, an update interval of the field for storing a state of traffic and an update interval of the field for storing the occurrence of an accident are not always required to be the same. The update interval of the field for storing a state of traffic may be set longer than the update interval of the field for storing the occurrence of an accident which requires prompter attention.

(3) ST3: Update Processing of the History-Information Management DB (Reception of the First Probe Information)

If the first probe information received from the on-vehicle system 10 includes user ID information, the information management center 20 updates the table 2051 having the user ID information in the history-information management DB 205.

To be more specific, as soon as the history-information management unit 202 receives user ID information together with the first probe information from the on-vehicle system 10 through the network IF unit 201, the history-information management unit 202 adds a new record 2052 to the table 2051 having the user ID information in the history-information management DB 205. After that, in this record, current time is registered in a field for storing the received date and time; the position information received together with the first probe information is registered in a field for storing the position information; the classification of information determined according to contents of the first probe information is registered in a field for storing the classification of information (in the case of running information such as vehicle speed and a following distance, the probe A is registered, and in the case of information indicating the occurrence of an accident, the probe B is registered); and the number of points determined according to the classification of information is registered in a field for storing a point occurred.

(4) ST4: Extraction Processing of the Second Probe Information and the Advertisement Information

If the first probe information received from the on-vehicle system 10 includes a request area, second probe information of which is requested, the information management center 20 transmits the second probe information of the area to the on-vehicle system 10 as a sender of the first probe information. In this case, if there is advertisement information of this area, the advertisement information is also transmitted together.

More specifically, as soon as the second probe-information management unit 204 receives a request area, second probe information of which is requested, together with the first probe information and the position information, from the on-vehicle system 10 through the network IF unit 201, the second probe-information management unit 204 extracts all records 2072 that are registered in the table 2071 corresponding to this area in the second probe-information management DB 207. Thereafter information included in these records is treated as the second probe information.

Next, the second probe-information management unit 204 notifies the advertisement-information management unit 203 of the request area of second probe information, which has been received from the on-vehicle system 10. In response to this, the advertisement-information management unit 203 searches the advertisement-information management DB 206 for the table 2061 having area information included in the notified request area. If such a table 2061 is detected, the advertisement-information management unit 203 notifies the second probe-information management unit 204 of an advertisement information address and sponsor ID information which are described in this table 2061. If there is no such a table 2061, the advertisement-information management unit 203 notifies the second probe-information management unit 204 of “no advertisement information”.

As soon as the second probe-information management unit 204 is notified of “no advertisement information” by the advertisement-information management unit 203, the second probe-information management unit 204 transmits the second probe information to the on-vehicle system 10 as a sender of the first probe information through the network IF unit 201. On the other hand, if the second probe-information management unit 204 is notified of an advertisement information address and a sponsor ID by the advertisement-information management unit 203, the second probe-information management unit 204 accesses this address to read the advertisement information. Then, the second probe-information management unit 204 transmits the second probe information, the advertisement information, and the sponsor ID to the on-vehicle system 10 as the sender of the first probe information through the network IF unit 201.

(5) ST5: Acknowledgment Processing of Advertisement-Information Viewing

In the on-vehicle system 10, when the main control unit 101 receives the second probe information through the network IF unit 102, the main control unit 101 presents the second probe information to a user through the user IF unit 105. At this time, if advertisement information and sponsor ID information are received together with the second probe information, the main control unit 101 notifies a user of the receipt through the user IF unit 105, and registers the advertisement information and the sponsor ID information, which have been received, in the memory card 110 through the memory-card control unit 103.

By the way, after that, when a user notifies the control unit 101, through the user IF unit 105, that the user wants to view the advertisement information, the control unit 101 reads the advertisement information from the memory card 110 through the memory-card control unit 103. Then, the control unit 101 presents the read advertisement information to the user through the user IF unit 105. At this time, if the user uses the user IF unit 105 to instruct the control unit 101 to transmit advertisement-information viewing acknowledgment, the control unit 101 transmits viewing acknowledgment information including the sponsor ID information to the information management center 20, together with the user ID information and the vehicle position information, after the presentation of the advertisement information.

(6) ST6: Update Processing of the History-Information Management DB (Reception of Viewing Acknowledgment Information)

Upon receiving viewing acknowledgment information from the on-vehicle system 10, the information management center 20 updates the table 2051 having the user ID information, which has been received together with the viewing acknowledgment information, in the history-information management DB 205.

To be more specific, upon receiving viewing acknowledgment information from the on-vehicle system 10 through the network IF unit 201, the history-information management unit 202 adds a new record 2052 to the history table 2051 having the user ID information, which has been received together with the viewing acknowledgment information, in the history-information management DB 205. Then, in this record, current time is registered in a field for storing the received date and time; the position information which has been received together with the viewing acknowledgment information is registered in a field for storing the position information; the classification of information which indicates that it is viewing acknowledgment is registered in a field for storing the classification of information; and the number of points determined according to the classification of information is registered in a field for storing a point occurred.

(7) ST7: Update Processing of the Advertisement-Information Management DB (Receiving of Viewing Acknowledgment Information)

Upon receiving viewing acknowledgment information from the on-vehicle system 10, the information management center 20 updates the table 2061 having the sponsor ID information, which is included in the viewing acknowledgment information, in the advertisement-information management DB 206.

More specifically, upon receiving viewing acknowledgment information from the on-vehicle system 10 through the network IF unit 201, the advertisement-information management unit 203 adds a new record 2062 to the table 2061 having the sponsor ID information, which is included in the viewing acknowledgment information, in the advertisement-information management DB 206. Then, in this record, current time is registered in a field for storing the received date and time; the user ID information which has been received together with the viewing acknowledgment information is registered in a field for storing user ID information; the classification of information which indicates that it is viewing acknowledgment is registered in a field for storing the classification of information; and the number of points determined according to the classification of information is registered in a field for storing a point occurred.

(8) ST8: Use Certificate Issuance Processing

If the user who viewed the advertisement information using the on-vehicle system 10 utilizes a facility of the advertiser, the user presents the memory card 110 which stores the advertisement information and the sponsor ID information to a clerk at the window of the facility. The advertiser terminal 30 generates data for certifying use of the facility according to an instruction by the clerk at the window or the like, and then stores the data in the memory card 110.

More specifically, through the memory-card control unit 302, the main control unit 306 reads the advertisement information and the sponsor ID information from the memory card 110 which has been received from the user of the on-vehicle system 10. Then, the main control unit 306 presents the read information to the clerk at the window or the like, through the user IF unit 305. This enables the clerk at the window to check whether or not the user of the on-vehicle system 10 has viewed the advertisement information of the company to which the clerk belongs.

Next, if the clerk at the window uses the user IF unit 305 to instruct the main control unit 306 to generate use certificate data, the main control unit 306 generates use certificate data (for example, an electronic signature for a sponsor ID, etc.), and then registers the use certificate data in the memory card 110, which has been received from the user of the on-vehicle system 10, through the memory-card control unit 302.

(9) ST9: Acknowledgment Processing of Advertisement-Information Use

In the on-vehicle system 10, when the user uses the user IF unit 105 to instruct transmission of the advertisement information using acknowledgment, the main control unit 101 accesses the memory card 110 through the memory-card control unit 103, and then checks that the use certificate data of the advertiser and the sponsor ID information are stored. After that, together with the user ID information and the vehicle position information, the main control unit 101 transmits the use acknowledgment information including the use certificate data and the sponsor ID information to the information management center 20.

(10) ST10: Update Processing of the History-Information Management DB (Reception of Use Acknowledgment Information)

Upon receiving use acknowledgment information from the on-vehicle system 10, the information management center 20 updates the table 2051 having the user ID information, which has been received together with the use acknowledgment information, in the history-information management DB 205.

To be more specific, upon receiving use acknowledgment information from the on-vehicle system 10 through the network IF unit 201, the history-information management unit 202 adds a new record 2052 to the table 2051 having the user ID information, which has been received together with the use acknowledgment information, in the history-information management DB 205. Then, in this record, current time is registered in a field for storing the received date and time; the position information which has been received together with the use acknowledgment information is registered in a field for storing the position information; the classification of information which indicates that it is use acknowledgment is registered in a field for storing the classification of information; and the number of points determined according to the classification of use is registered in a field for storing a point occurred.

(11) ST11: Update Processing of the Advertisement-Information Management DB (Reception of Use Acknowledgment Information)

Upon receiving use acknowledgment information from the on-vehicle system 10, the information management center 20 updates the table 2061 having the sponsor ID information, which is included in the use acknowledgment information, in the advertisement-information management DB 206.

To be more specific, upon receiving use acknowledgment information from the on-vehicle system 10 through the network IF unit 201, the advertisement-information management unit 203 checks use certificate data included in the use acknowledgment information in the advertisement-information management DB 206. For example, if the use certificate data is an electronic signature, the advertisement-information management unit 203 checks the electronic signature using a check key registered beforehand in association with sponsor ID information included in the use acknowledgment information. After that, the advertisement-information management unit 203 adds a new record 2062 to the table 2061 having this sponsor ID information. Then, in this record, current time is registered in a field for storing the received date and time; the user ID information which has been received together with the use acknowledgment information is registered in a field for storing user ID information; the classification of information which indicates that it is use acknowledgment is registered in a field for storing the classification of information; and the number of points determined according to the classification of use is registered in a field for storing a point occurred.

One embodiment according to the present invention has been described as above.

In this embodiment, the on-vehicle system 10 can enjoy the second probe information managed by the information management center 20 on the condition that the on-vehicle system 10 provides the first probe information which has been collected by itself. In other words, all users of the system are required to become a provider of the first probe information. As a result, as the number of system users increases, the number of providers of the first probe information also increases without fail. Accordingly, it is expected that the first probe information can be obtained from a greater number of on-vehicle systems 10.

In addition, in this embodiment, the user of the on-vehicle system 10 is inquired whether or not the user will transmit user ID information. Only when it is judged that the user has an intention of transmitting the user ID information, the user ID information is transmitted from the on-vehicle system 10 to the information management center 20 together with the first probe information. In the information management center 10, only when the user ID information is received together with the first probe information, a discount point for a use fee of the second probe information is given. In other words, if the user gives up the discount of the second probe information use fee, the user is not required to transmission the user ID information to the information management center 20. Thus, according to this embodiment, since the protection of privacy of users who use the on-vehicle system 10 is considered more practically, the usability of the users increases.

Moreover, in this embodiment, advertisement information of a request area, second probe information of which is requested by a user, is transmitted to the on-vehicle system 10 of the user. If this user transmits viewing, and use, of the advertisement information to the information management center 10 together with user ID information, the user can obtain a discount point for a use fee of the second probe information. In other words, as the number of times the user views, or uses, advertisement information increases, the extent to which a use fee of the second probe information is reduced becomes larger. Therefore, it is possible to reduce an economical load on the users of the system.

On the other hand, when it is detected that the advertisement information has been actually viewed or used, a point of an advertisement rate is given to the advertiser. More specifically, because an advertisement rate can be determined according to practical effects of the advertisement information, participation of an advertiser as a sponsor also becomes easy.

Further, in this embodiment, the number of discount points for the use fee of the second probe information, which are given in exchange for the provision of the first probe information, is changed according to the value of the information. To be more specific, information which needs urgent attention such as the occurrence of an accident is classified as the probe B having the high value of information; and running information and the like are classified as the probe A. Here, it is so devised that the number of points which are given to the probe B is greater than the number of points which are given to the probe A. If points are given in this manner, it is possible to expect that the greater amount of precious information is provided. Additionally, this prevents inundation of information having a low value.

It is to be noted that the present invention is not limited to the above-mentioned embodiment, and it can be modified in various ways within the points of the present invention.

For example, in the above-mentioned embodiment, a case where the memory card 110 is used as a means for storing the advertisement information and the sponsor ID information has been exemplified. However, as a matter of course, it is also possible to use a storage medium other than the memory card (for example, a magnetic card). Moreover, it is also possible to use a portable terminal equipped with a memory.

Further, in the above-mentioned embodiment, the user IF unit 105 of the on-vehicle system 10 may be a GUI; or it may also be so devised that information is exchanged with a user by means of voice using a voice recognition technology.

In addition, in the embodiment described above, the traffic information management system which uses the on-vehicle system as a mobile terminal was described as an example. However, the present invention can be broadly applied to an information management system which uses various kinds of mobile terminals (cellular phone, PDA (Personal Digital Assistance), etc.) that have a communication function of communicating with an information management device.

As described above, according to the present invention, collection of information from a greater number of mobile terminals becomes possible in the information management system.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. An information management system, comprising:
at least one mobile terminal; and
an information management device that is connected to the mobile terminal via a network,
wherein said information management device comprising:
first probe information receiving means for receiving first probe information from the mobile terminal together with position information;
second probe information registering means for classifying the first probe information received by the first probe information receiving means on an area basis, said area being determined by the position information received together with the first probe information, and processing the first probe information into second probe information before registering the second probe information;
history registering means by which if the first probe information received by the first probe information receiving means has user ID information as well as the position information, management information including the position information and its received date and time is associated with the user ID information, and is registered as discount information of a second probe information use fee; and
second probe information transmitting means for transmitting second probe information about an area requested by the sender to a sender of the first probe information received by the first probe information receiving means; and
said mobile terminal comprising:
position information obtaining means for obtaining position information of the mobile terminal;
first probe information obtaining means for obtaining the first probe information;
storing means for storing the user ID information;
user ID transmission acknowledging means for accepting acknowledgment of transmission of the user ID information from a user; and
second probe information obtaining means by which if the user ID transmission acknowledging means judges that the user ID information is not transmitted, the position information obtained by the position information obtaining means, the first probe information obtained by the first probe information obtaining means, and a request area, the second probe information of which is requested, are transmitted to the information management device, whereas if the user ID transmission acknowledging means judges that the user ID information is transmitted, the user ID information stored in the storing means is transmitted to the information management device together with the position information, the first probe information, and the request area so as to receive the second probe information of the request area from the information management device.

2. An information management system according to claim 1, wherein:
said first probe information includes a moving speed of the mobile terminal; and
said second probe information registering means classifies the first probe information, which has been received by the first probe information receiving means within a given period of time, on an area basis, said area being determined by the position information received together with the first probe information, and then the second probe information registering means estimates a state of traffic jam in each area from a mean value of the first probe information of all areas to register the estimated state as the second probe information of each area.

3. An information management system according to claim 1 or 2, wherein:
said information providing device further comprises an advertisement information database in which advertisement information of a facility located in each area is registered; and
said second probe information transmitting means transmits the second probe information, which is classified and registered corresponding to a request area of the second probe information, said request area having been received together with the first probe information, to a sender of the first probe information received by the first probe information receiving means, together with advertisement information which is associated with the request area and is registered in the advertisement information database.

4. An information management system according to claim 3, wherein:
said second probe information obtaining means notifies a user of advertisement information if the second probe information obtaining means receives the advertisement information from the information management device together with the second probe information;
said mobile terminal further comprises a viewing acknowledgment transmitting means that accepts, from the user, viewing acknowledgment of the advertisement information notified by the second probe information obtaining means, and that transmits the viewing acknowledgment to the information management device together with the user ID information stored in the storing means;
said information management device further comprises a viewing acknowledgment receiving means that receives the viewing acknowledgment from the mobile terminal; and
said history registering means associates management information, which includes the viewing acknowledgment received by the viewing acknowledgment receiving means and its received date and time, with the user ID information given to the viewing acknowledgment, and then registers the management information as discount information of a second probe information use fee.

5. An information management system according to claim 3, wherein:
said second probe information obtaining means notifies a user of advertisement information if the second probe information obtaining means receives the advertisement information from the information management device together with the second probe information;
said mobile terminal further comprises a use acknowledgment transmitting means that transmits use acknowledgment of advertisement information notified by the second probe information obtaining means to the information management device together with ID information stored in the storing means;
said information management device further comprises a use acknowledgment receiving means that receives use acknowledgment from the mobile terminal; and
said history registering means associates management information, which includes the use acknowledgment received by the use acknowledgment receiving means and its received date and time, with the user ID information given to the use acknowledgment, and then registers the management information as discount information of a second probe information use fee.

6. An information management system according to claim 5, wherein:
said use acknowledgment includes sponsor ID information of the advertisement information notified by the second probe information obtaining means; and
said information management device further comprises a use acknowledgment measuring means that measures the number of use acknowledgment, which has been received by the use acknowledgment receiving means, for each piece of sponsor ID information.

7. An information management device that is used in the information management system according to claim 1, 2, 3, 4, 5, or 6.

8. A mobile terminal that is used in the information management system according to claim 1, 2, 3, 4, 5, or 6.

9. A program which is read and executed by a computer system so that an information management device is built on the computer system, said information management device being used in the information management system according to claim 1, 2, 3, 4, 5, or 6.

10. A program that is read and executed by a portable computer system so that a mobile terminal is built on the portable computer system, said mobile terminal being used in the information management system according to claim 1, 2, 3, 4, 5, 6, or 7.

11. An information management method for managing collection, and provision, of information using at least one mobile terminal, and an information management device that is connected to the mobile terminal via a network, said information management method comprising:
a first step in which after obtaining first probe information by the mobile terminal, the first probe information is transmitted to the information management device together with position information of the mobile terminal, and a request area, second probe information of which is requested, and if the mobile terminal accepts, from a user of the mobile terminal, an instruction that ID information of the mobile terminal and/or ID information of the user are to be transmitted, the ID information is also transmitted to the information management device;
a second step in which the information management device receives the first probe information, and classifies the first probe information on an area basis, said area being determined by position information which is added to the first probe information, then the information management device processes the first probe information into second probe information before registering the second probe information;
a third step in which if the first probe information received by the information management device has ID information as well as position information, management information including the position information and its received date and time is associated with the ID information, and is registered as discount information of a second probe information use fee;
a fourth step in which said information management device transmits second probe information about an area requested by the sender to a sender of the received first probe information; and
a fifth step in which said mobile terminal receives the second probe information from the information management device, and notifies the mobile terminal user of the second probe information.
